(19) United States
(12) Patent Application Publication
(10) Pub. No.: US 2003/0174065 A1
(43) Pub. Date: Sep. 18, 2003

(54) Passive vehicle actuation card incorporated into personal use item

(75) Inventor: Allan Losey, Ortonville, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/387,099

(22) Filed: Mar. 12, 2003

Related U.S. Application Data
(60) Provisional application No. 60/363,731, filed on Mar. 12, 2002.

(51) Int. Cl. G08C 19/00

(52) U.S. Cl. 340/825.72; 340/5.72

(57) ABSTRACT

A passive entry system for use in providing access to a vehicle incorporates a circuit associated with a personal use item utilized by the vehicle operator for some function other than vehicle access control. As an example, the personal use item is preferably a watch. The circuit may be incorporated into the dial or the band of the watch. Moreover, the circuit may be powered by a query signal from the vehicle, or may be powered by a battery on the personal use item. In other embodiments, the circuit is incorporated into a piece of jewelry. The use of the item which is otherwise carried by the vehicle operator to also provide the passive access apparatus greatly reduces the likelihood of a vehicle operator forgetting to bring the passive access apparatus along when requesting access to a vehicle.

The present invention claims priority to U.S. Provisional Patent Application serial No. 60/636,731 filed on Mar. 12, 2002.

### BACKGROUND OF THE INVENTION

This invention relates to the incorporation of a passive access apparatus for communicating with a vehicle control to ensure that a user attempting access to the vehicle is an appropriate user. The passive access apparatus is incorporated into a personal use item otherwise utilized by the operator of the vehicle.

Various passive access features are incorporated into modem vehicles. As an example, recently, access to the vehicle door lock has been controlled through a remote keyless entry system requiring the use of a key fob having switches actuated by the user to lock or unlock the vehicle doors. More recently, it has been known to provide passive key cards or other access authorization items. Such items incorporate a small circuit which is capable of sending a communication to a vehicle control carrying a code received and interpreted by the vehicle control, and utilized to ensure an operator requesting access to the vehicle is an appropriate operator. These controls are generally known in the art.

There are several types of such controls. The vehicle may periodically send out an access inquiry signal. This signal is received by the passive access card which then sends a response signal carrying its coded signal. The vehicle receiver receives this coded signal and interprets the coded signal to ensure proper authorization. Another type only sends the query when access is requested, such as when a vehicle door handle is pulled to open the door.

The two other features in such systems relate to how the passive access card is powered. In a first type, a so-called LF link utilizes the “query” from the vehicle to also power a coil on the access card. Such “inductive linkage” is known in the art. The coil is powered by the signal and sends its response back to the vehicle. A second type may utilize the query signal as an initiation to send a signal back to the vehicle. This type of access card may have a battery to power its signal.

Such passive access systems are utilized not only on vehicle doors, but also on the ignition of many modern vehicles. Typically, the passive access apparatus is incorporated into the key in some fashion and is queried when the key is inserted into the vehicle ignition.

The general type of passive access card now being utilized to control access to vehicle door locks do require that an operator bring the passive access card with him. That is, if the vehicle operator forgets to have the card, then there will be no access to the vehicle.

It would be desirable to further ensure the vehicle operator is likely to have the passive access card with him when approaching a vehicle to request access to the vehicle.

### SUMMARY OF THE INVENTION

In a disclosed embodiment of this invention, a passive access apparatus is incorporated into an item otherwise worn or carried by a vehicle operator for some purpose not relating to vehicle access. While there are a large number of such items that could potentially incorporate the access apparatus, several will be disclosed. Even so, generically, this invention relates to the incorporation of a passive access apparatus into an item utilized by a vehicle operator for a second function not related to vehicle access.

In disclosed embodiments, the passive access apparatus is incorporated into a watch worn or carried by the vehicle operator. The passive access apparatus may be incorporated into the watchband, or into the watch dial itself. The passive access apparatus may be powered by an inductive link, or may utilize the watch battery for sending its signal.

In other embodiments, the passive access apparatus is incorporated into jewelry. Again, the main feature of this invention is the incorporation of the passive access apparatus into some item which is utilized by the vehicle operator for some second function.

These and other features of this invention can be best understood from the following specification and drawings, the following of which is a brief description.

### BRIEF DESCRIPTION OF THE DRAWINGS

FIG. 1 is a schematic view of a first embodiment of this invention.

FIG. 2 shows a second embodiment.

FIG. 3 shows a third embodiment.

### DETAILED DESCRIPTION OF THE PREFERRED EMBODIMENT

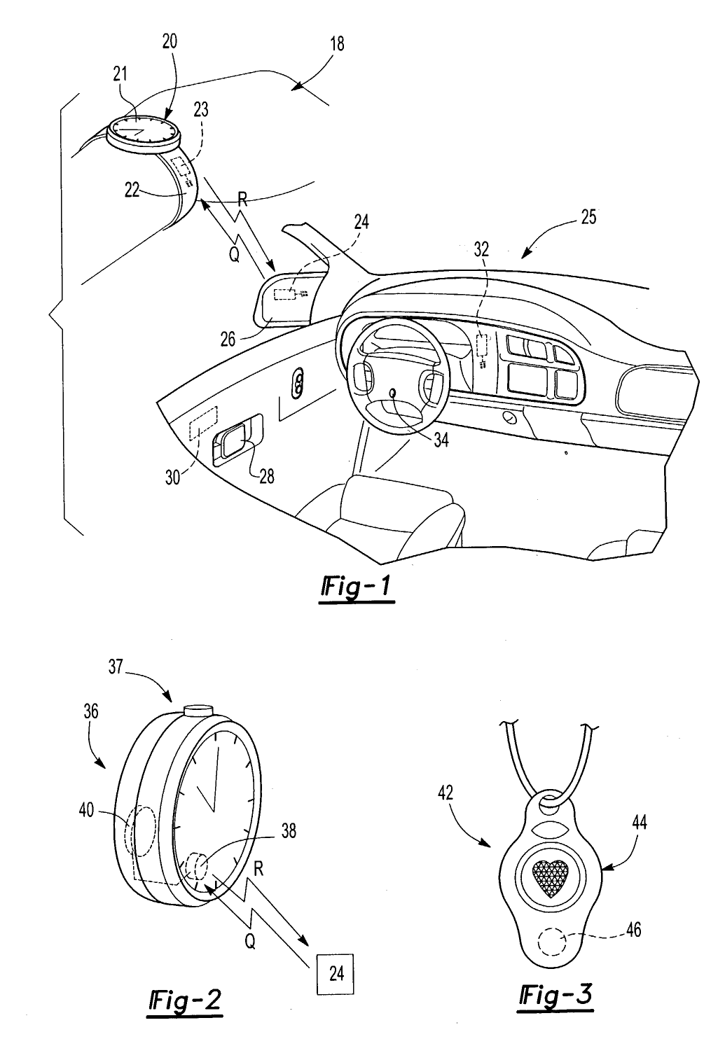

As shown in FIG. 1, a vehicle operator 18 is wearing a watch 20 including a dial 21 and a watchband 22. A control circuit 23 is incorporated into the watchband 22. The control circuit 23 includes an antenna for receiving and sending signals. Further, circuitry for receiving a signal from an associated vehicle transmitter and associated central circuit 24 is incorporated into circuit 23. As shown, the circuit 24 is provided in a side view mirror 26. The circuit 24 is operable to control locking or unlocking of a vehicle lock 30.

In some applications, actuation of the latch 28 for the lock 30 sends a signal to the circuit 24 to send a query signal Q. That is, when someone pulls latch 28 to open a door, signal Q is sent. Signal Q is received by the antenna associated with the circuit 23. The signal Q includes both a code unique to the vehicle 25, and a powering signal. A coil within the circuit 23 utilizes the powering signal to power and send a return signal R. That is, generation and transmission of return signal R is powered by the inductive coupling, as is known in the prior art. The return signal R includes a code unique to the circuit 23. This is received at the receiver 24 and decoded. If the code is an appropriate one for the vehicle 25, then a signal is sent to actuate the lock 30.

Other ways of generating the query signal come within the scope of this invention. As an example, it is also known in the prior art that the query signal Q simply be periodically sent. If the code in the response R is appropriate, then the lock 30 will be unlocked and the vehicle operator will have access to the interior of the vehicle.

As shown schematically again, another transmitter/receiver control circuit 32 may be placed in the vehicle adjacent to an ignition request button 34. A similar query and response may then be sent to ensure that the vehicle operator has the appropriate coded access apparatus 23 before the control for the vehicle will allow the vehicle ignition to start.

Since the circuit 23 is incorporated into an item typically always worn by an operator, namely a watch, the likelihood of the vehicle operator not carrying the coded access apparatus 23 is greatly reduced when compared to the prior art. Thus, there are benefits with regard to the practical operation of this type of passive access system.

FIG. 2 shows another embodiment 36 wherein a watch 37 carries the circuit 38 in its dial. This embodiment is shown as a pocket watch, although the wrist watch of FIG. 1 may also incorporate the transponder mounted directly into the dial. As shown in this embodiment, the battery 40 which otherwise powers the watch 37 may be utilized for powering the circuit 38. Again, as known in the prior art, a query signal is received from the vehicle control 24 which results in the creation of a coded return signal R from the watch 37.

FIG. 3 shows yet another embodiment 42. As shown in embodiment 42, a piece of jewelry such as a pendant 44 may incorporate the circuit 46. Again, this type of jewelry is regularly, and in many cases, always worn by many users. Thus, the likelihood of a user not having coded access apparatus 44 with him when requesting access to a vehicle is greatly reduced when compared to the prior art.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A vehicle access apparatus comprising:
an item typically utilized by a vehicle operator for performing a second function not related to requesting access to a vehicle; and
a circuit incorporated into said item, said circuit being capable of receiving a signal from a vehicle requesting a coded signal to be sent, said circuit further being capable of sending a coded signal to a control associated with a vehicle.

2. An apparatus as set forth in claim 1, wherein said item is a watch.

3. An apparatus as set forth in claim 2, wherein said circuit is incorporated into a watchband.

4. An apparatus as set forth in claim 2, wherein said circuit is incorporated into the dial of a watch.

5. An apparatus as set forth in claim 4, wherein said circuit is powered by a battery associated with said watch.

6. An apparatus as set forth in claim 2, wherein said circuit is inductively coupled to a query signal received from a vehicle to power said circuit and send a return signal to the vehicle.

7. An apparatus as set forth in claim 1, wherein said item is a piece of jewelry.

8. An apparatus as set forth in claim 7, wherein said circuit is inductively coupled to a query signal received from a vehicle to power a return signal.

9. An access system for a vehicle comprising:
a vehicle transmitter/receiver circuit associated with a vehicle, and said vehicle transmitter/receiver communicating with a control to control access to a system on said vehicle;
an item typically utilized by a vehicle operator for performing a second function not related to requesting access to a vehicle; and
a circuit for sending and receiving signals to said vehicle, said circuit being incorporated into said item, and said circuit being capable of receiving a signal from said vehicle requesting a coded signal to be sent, said circuit further being capable of sending a coded signal to said control on said vehicle.

10. A system as set forth in claim 9, wherein said item is a watch.

11. A system as set forth in claim 10, wherein said circuit is incorporated into a watchband.

12. A system as set forth in claim 10, wherein said circuit is incorporated into the dial of a watch.

13. A system as set forth in claim 12, wherein said circuit is powered by a battery associated with said watch.

14. A system as set forth in claim 10, wherein said circuit is inductively coupled to a query signal received from a vehicle to power said circuit and send a return signal to the vehicle.

15. An apparatus as set forth in claim 9, wherein said item is a piece of jewelry.

16. An apparatus as set forth in claim 15, wherein said circuit is inductively coupled to a query signal received from a vehicle to power a return signal.
